(19) United States
(12) Patent Application Publication
(10) Pub. No.: US 2026/0275017 A1
(43) Pub. Date: Sep. 17, 2026

(54) CYCLIC OLEFIN COPOLYMER AND CURABLE COMPOSITION

(71) Applicant: CPC CORPORATION, TAIWAN, Kaohsiung City (TW)

(72) Inventors: Lin-Chiang HUANG, Chia-Yi City (TW); Ching-Hsuan Lin, Taichung City (TW); Yi-Chun Chen, Taichung City (TW); Ying-Xuan Chen, Taichung City (TW); Ching-Ting Huang, Taichung City (TW); Jui-Fu KAO, Chia-Yi City (TW); Hsin-Lung LEE, Chia-Yi City (TW); Way-Chih HSU, Chia-Yi City (TW); Wei-Yen CHEN, Chia-Yi City (TW); Chih-Yung TSAI, Chia-Yi City (TW); Ming-Yu HUANG, Chia-Yi City (TW); Jann-Chen Lin, Chia-Yi City (TW)

(73) Assignee: CPC CORPORATION, TAIWAN, Kaohsiung City (TW)

(21) Appl. No.: 19/097,907

(22) Filed: Apr. 2, 2025

(30) Foreign Application Priority Data
Mar. 13, 2025 (TW) 114109370

(51) Int. Cl. C08F 230/02; C08K 5/3432; C08K 5/3445; C08K 5/50

(52) U.S. Cl. CPC C08F 230/02; C08K 5/3432; C08K 5/3445; C08K 5/50

(57) ABSTRACT

A cyclic olefin copolymer has a structure as shown in Formula (I-1) or Formula (I-2):

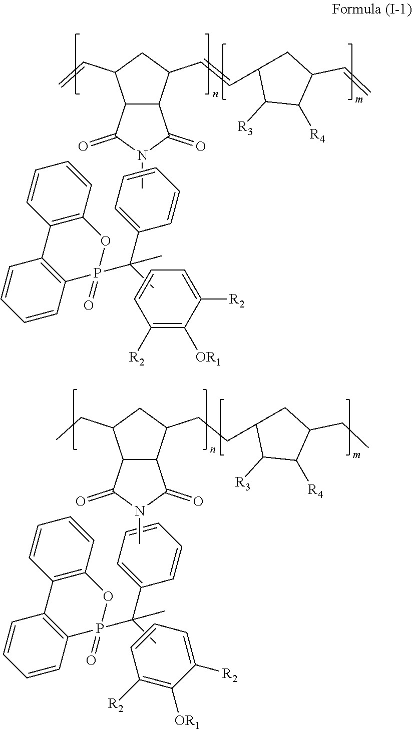

Formula (I-2), wherein R₁ is

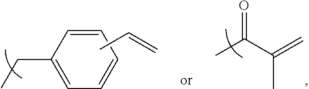

R₂ is hydrogen, halogen or C₁-C₆ alkyl, R₃ and R₄ are independently selected from the groups consisting of hydrogen, C₁-C₆ alkyl, phenyl group and CF₃ group, n is a positive integer from 5 to 200, m is a positive integer from 5 to 200. The cyclic olefin copolymer is suitable for the preparation of a cured product of cyclic olefin copolymer with high processability, high heat resistance, good dielectric ability and high toughness and flame retardancy. A curable composition is also provided.

### CROSS-REFERENCE TO RELATED APPLICATION

This non-provisional application claims priority under 35 U.S.C. § 119(a) on Patent Application No(s). 114109370 filed in Taiwan, R.O.C. on Mar. 13, 2025, the entire contents of which are hereby incorporated by reference.

### BACKGROUND OF THE INVENTION

### 1. Field of the Invention

The present disclosure relates to a cyclic olefin copolymer, in particular to a cyclic olefin copolymer whose molecular structure includes a phosphorus-containing flame-retardant group. The present disclosure also relates to a curable composition.

### 2. Description of the Related Art

Norbornene is an unsaturated cyclic olefin compound. As shown in chemical formula 1 below, norbornene can be obtained from cyclopentadiene and ethylene, which are by-products of petroleum cracking, by the Diels-Alder reaction.

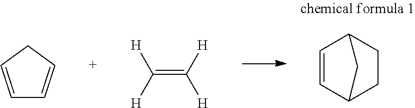

Norbornene can form a cyclic olefin polymer (COP) by ring-opening metathesis polymerization (ROMP), and the chemical structure thereof and reaction mechanism are shown in the following chemical formula 2.

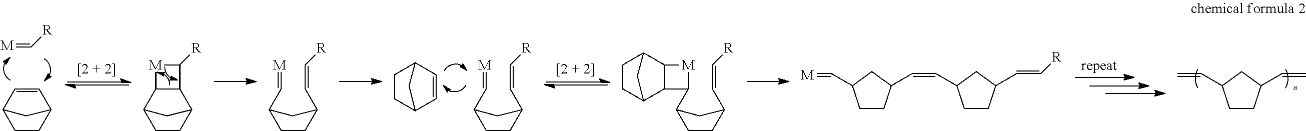

The saturated aliphatic and rigid cyclic structures in the structure of cyclic olefin polymer (COP) make COP exhibit good chemical resistance, high optical transparency, low moisture absorption and low dielectric constant. However, due to the large number of aliphatic in the structure, the glass transition temperature is relatively low (Tg<80° C.).

In order to improve the thermal properties of cyclic olefin polymer (COP), the material can achieve flame retardant effect through thermal cross-linking. In the development of flame retardant materials, halogen-containing flame retardants were added in the early stage, but they released highly toxic substances during the combustion process to endanger health, and then phosphorus-containing flame retardants were used.

### BRIEF SUMMARY OF THE INVENTION

Traditional cyclic olefin polymers still have room for improvement. Therefore, the present disclosure introduces a phosphorus-based structure into the cyclic olefin copolymer, so that it not only does not produce toxic substances when burned, but also can achieve the effect of flame resistance.

In order to achieve the above purpose and other purposes, the present disclosure provides a cyclic olefin copolymer has a structure as shown in Formula (I-1) or Formula (I-2):

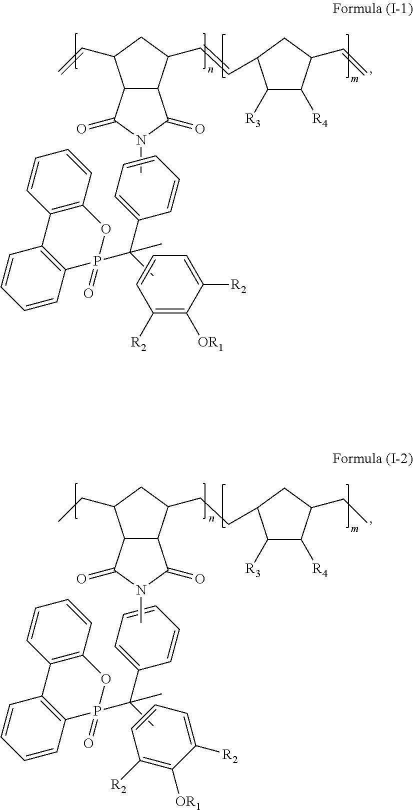

wherein R₁ is

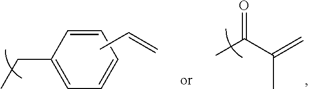

R₂ is hydrogen, halogen or C₁-C₆ alkyl, R₃ and R₄ are independently selected from the groups consisting of hydrogen, C₁-C₆ alkyl, phenyl group and CF₃ group, n is a positive integer from 5 to 200, m is a positive integer from 5 to 200.

In an embodiment of the present disclosure, the cyclic olefin copolymer has a structure as shown in Formula (II):

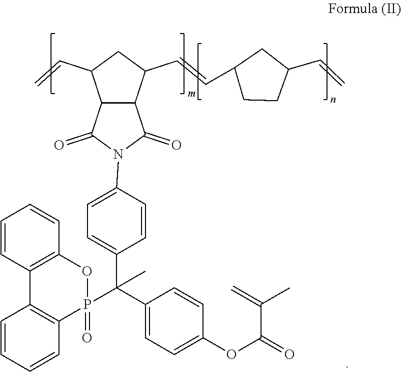

In an embodiment of the present disclosure, the cyclic olefin copolymer has a structure as shown in Formula (III):

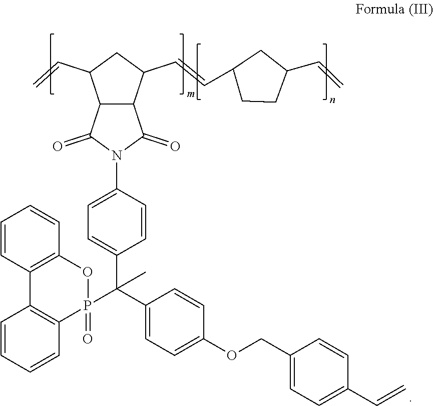

In an embodiment of the present disclosure, the cyclic olefin copolymer has a structure as shown in Formula (IV):

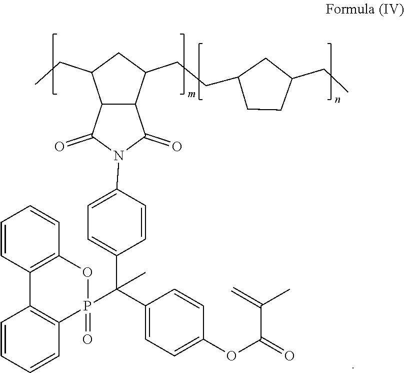

In an embodiment of the present disclosure, the cyclic olefin copolymer has a structure as shown in Formula (V):

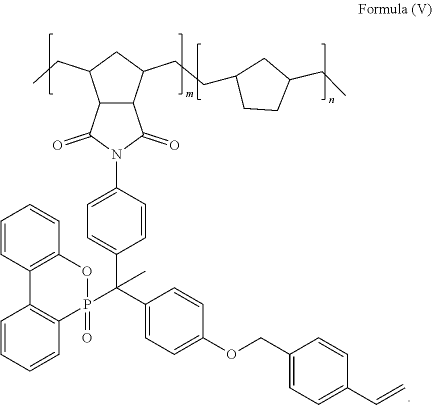

In order to achieve the above purpose and other purposes, the present disclosure provides a curable composition, including:
the cyclic olefin copolymer as described above; and
a curing accelerator.

In an embodiment of the present disclosure, the curing accelerator is selected from the groups consisting of an imidazole-based curing accelerator, an amine-based curing accelerator and an organophosphorus-based curing accelerator.

In an embodiment of the present disclosure, the imidazole-based curing accelerator is selected from the groups consisting of imidazole, 2-methylimidazole and 2-methyl-4-ethylimidazole.

In an embodiment of the present disclosure, the amine-based curing accelerator is 4-dimethylaminopyridine (DMAP).

In an embodiment of the present disclosure, the organophosphorus-based curing accelerator is triphenylphosphine.

By introducing a phosphorus-based structure, the cyclic olefin copolymer of the present disclosure can form a cured product of the cyclic olefin copolymer with high processability, high heat resistance, good dielectric ability, high toughness and flame retardancy.

The curable composition of the present disclosure includes the above-described cyclic olefin copolymer, so that the cured product formed by it can have the above-described excellent characteristics.

### BRIEF DESCRIPTION OF THE DRAWINGS

For clarity, the thickness or size of each layer in the drawings is enlarged, omitted, or outlined. At the same time, the dimensions of each element do not fully reflect their true dimensions.

FIG. 1 is a 1H-NMR spectrum of a phosphorus-based monomer (1).

FIG. 2 is a 1H-NMR spectrum of a phosphorus-based monomer (2).

FIG. 3 is a 1H-NMR spectrum of a functionalized phosphorus-based monomer (1).

FIG. 4 is a 1H-NMR spectrum of a functionalized phosphorus-based monomer (2).

FIG. 5 is a 1H-NMR spectrum of a cyclic olefin copolymer (1).

FIG. 6 is a 1H-NMR spectrum of a cyclic olefin copolymer (2).

FIG. 7 is a 1H-NMR spectrum of a cyclic olefin copolymer (3).

FIG. 8 is a 1H-NMR spectrum of a saturated cyclic olefin copolymer (3).

FIG. 9 is a 1H-NMR spectrum of a functionalized saturated cyclic olefin copolymer (1).

FIG. 10 is a 1H-NMR spectrum of a functionalized saturated cyclic olefin copolymer (2).

### DETAILED DESCRIPTION OF THE INVENTION

In order to fully understand the objectives, characteristics, and effects of the present disclosure, by means of the following specific embodiments, the present disclosure is described below in detail.

The present disclosure provides a cyclic olefin copolymer (COC), specifically, a cyclic olefin copolymer including a structure derived from norbornene. The cyclic olefin copolymer of the present disclosure has a structure as shown in Formula (I-1) or Formula (I-2):

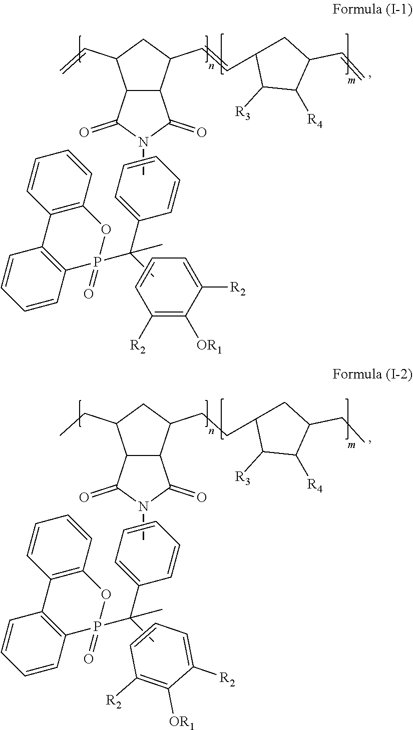

wherein R₁ is

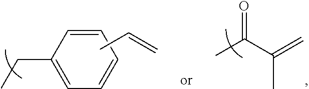

R₂ is hydrogen, halogen or C₁-C₆ alkyl, R₃ and R₄ are independently selected from the groups consisting of hydrogen, C₁-C₆ alkyl, phenyl group and CF₃ group, n is a positive integer from 5 to 200, m is a positive integer from 5 to 200.

### Preparation Method of Cyclic Olefin Copolymer

Norbornene phosphorus-containing compounds, norbornene and Grubb's catalyst are mixed for reaction to obtain a cyclic olefin copolymer of the present disclosure. For example, in the present embodiment, a molar ratio of norbornene phosphorus-containing compounds to norbornene may be 0.3 to 1.

In the present embodiment, the reaction of norbornene phosphorus-containing compounds with norbornene is carried out in the presence of a mono-component catalyst centered on transition metals and carbenes. The mono-component catalyst centered on transition metals and carbenes is such as Schrock catalyst, Grubbs catalyst, or a combination thereof. For example, a molar ratio of the mono-component catalyst centered on transition metals and carbenes to norbornene phosphorus-containing compounds can be 0.005 to 1.

Because the copolymer composition of the present disclosure has a linear phosphorus-containing aliphatic structure, if the copolymer is used as a flame retardant in the current polyphenylene ether (PPE) resin composition, the copolymer and the PPE resin produce a cross-linking reaction, and the heat resistance and flame resistance of the cured product of the PPE resin are improved without affecting the dielectric constant and loss tangent of the cured product.

### Copolymer Composition

The cyclic olefin copolymer described above is mixed with a curing accelerator to form the copolymer composition.

In the present embodiment, the molar number of the functionalized phosphorus-based monomer and the molar number of norbornene in the cyclic olefin copolymer may be 0.1 to 0.5. If the functionalized phosphorus-based monomer and norbornene are blended in the above range, a cured product of cyclic olefin copolymer with high processability, high heat resistance, good dielectric ability, high toughness and flame retardancy can be obtained.

In the present embodiment, the curing accelerator may be an imidazole-based curing accelerator, an amine-based curing accelerator, an organophosphorus-based curing accelerator or a combination thereof. In the present embodiment, the imidazole-based curing accelerator may be imidazole, 2-methylimidazole or 2-methyl-4-ethylimidazole. The organophosphorus-based curing accelerator may be triphenylphosphine. The amine-based curing accelerator may be 4-dimethylaminopyridine (DMAP).

When the above-mentioned curing accelerator is used, the amount of the curing accelerator is, for example, 0.1 wt % to 1.0 wt % based on the total weight of the copolymer composition.

In the present embodiment, the cyclic olefin copolymer composition of the present disclosure may be further heated and cured to obtain a cured product of the cyclic olefin copolymer with a cross-linking structure. The temperature of heat curing is, for example, 80° C. to 220° C.

The present disclosure uses a cyclic olefin copolymer represented by Formula (I-1) or Formula (I-2), wherein because it has a linear phosphorus-containing aliphatic structure, if the copolymer is used as a flame retardant in the current PPE resin composition, the copolymer and the PPE resin produce a cross-linking reaction, and the heat resistance and flame resistance of the cured product of the PPE resin are improved without affecting the dielectric constant and loss tangent of the cured product.

The present disclosure is further described below by several embodiments, but these embodiments are only for illustrative purposes and are not used to limit the scope of the present disclosure.

### Synthesis Embodiment 1

### Synthesis Embodiment 1-1: Synthesis of Phosphorus-Based Monomer (1)

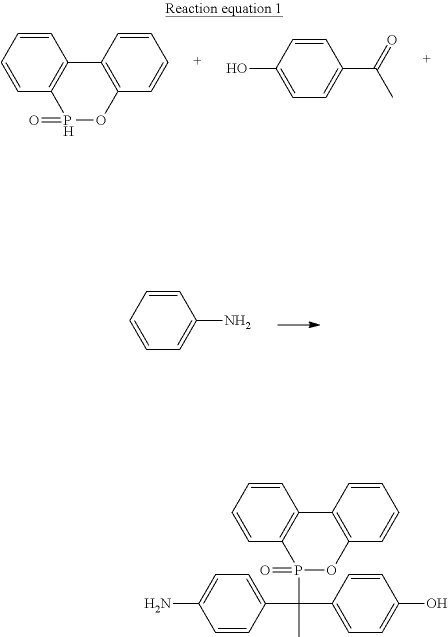

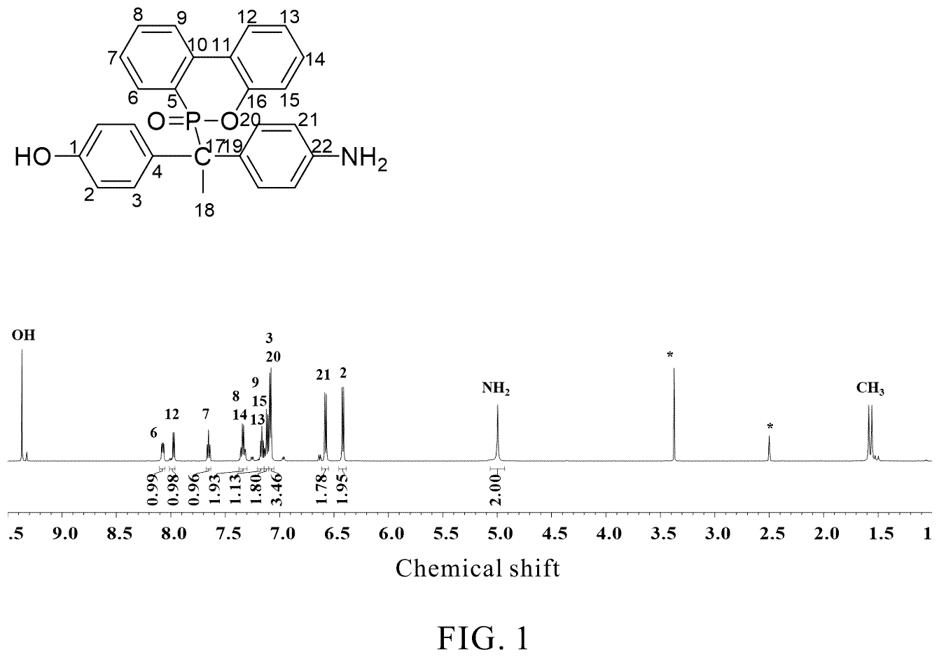

As shown in Reaction equation 1, 21.6 g (0.1 mol) of 9,10-dihydro-9-oxa-10-phosphaphenanthrene-10-oxide (DOPO), 13.6 g (0.1 mol) of 4-hydroxyacetophenone and 37.3 g (0.4 mole) of aniline are placed in a reactor, the temperature is raised to 130° C., after the reactants are completely dissolved and stirred evenly, 0.864 g (4 wt % of DOPO) of p-toluenesulfonic acid (PTSA) is added to the reactor, stirred at 130° C. for 24 hours, after the reaction is completed, it is precipitated with ethanol, washed three times, and a filter cake is dried in an 80° C. oven after suction filtration to obtain a light yellow powder, whose 1H-NMR spectrum is shown in FIG. 1.

### Synthesis Embodiment 1-2: Synthesis of Phosphorus-Based Monomer (2)

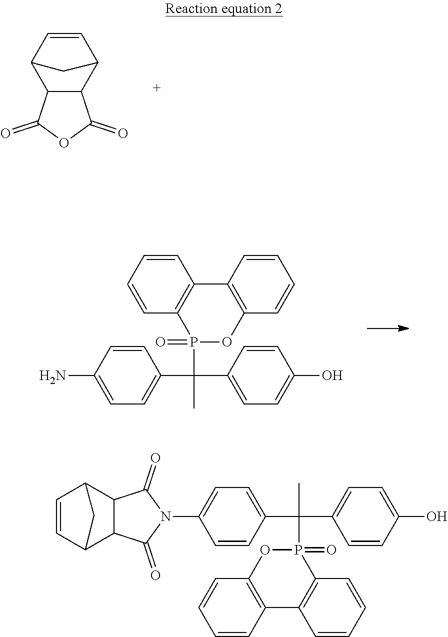 [SMILES: O=C1OC(=O)C2C3C=CC(C3)C12 ; CC(c1ccc(N)cc1)(c1ccc(O)cc1)P1(=O)Oc2ccccc2-c2ccccc21 ; CC(c1ccc(O)cc1)(c1ccc(N2C(=O)C3C4C=CC(C4)C3C2=O)cc1)P1(=O)Oc2ccccc2-c2ccccc21]

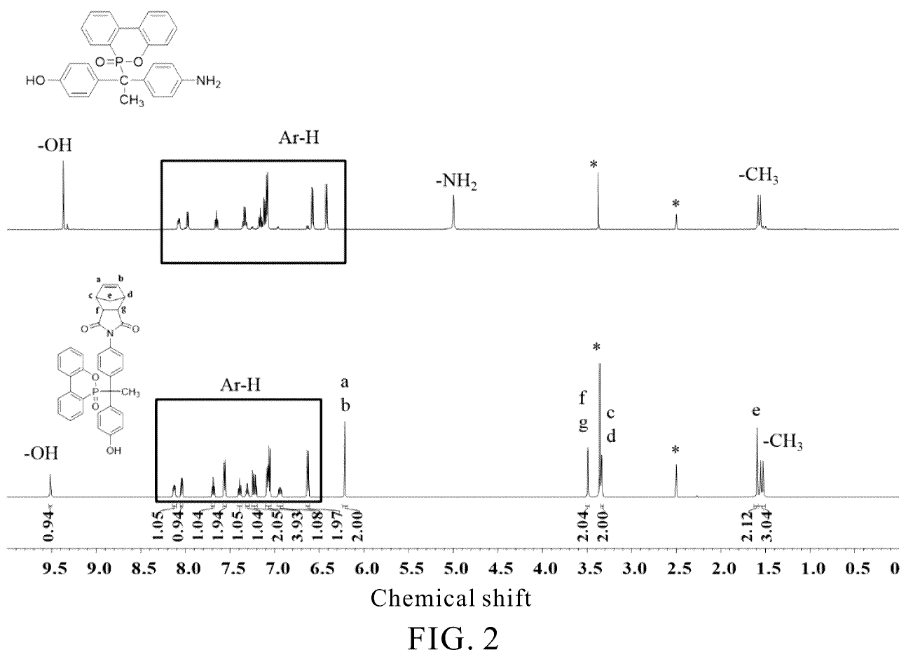

As shown in Reaction equation 2, 13 g (0.03 mol) of phosphorus-based monomer (1), 5 g (0.03 mol) of 5-norbornene-2,3-dicarboxylic anhydride and 30 mL of acetic acid are stirred in a 500 mL three-neck reactor, nitrogen is introduced and the temperature is raised to 100° C. After reacting for 12 hours, the product is filtered out and recrystallized with EtOH, and the crystals are filtered out and dried to obtain lavender crystals, whose 1H-NMR spectrum is shown in FIG. 2.

### Synthesis Embodiment 2

### Synthesis Embodiment 2-1: Synthesis of Functionalized Phosphorus-Based Monomer (1)

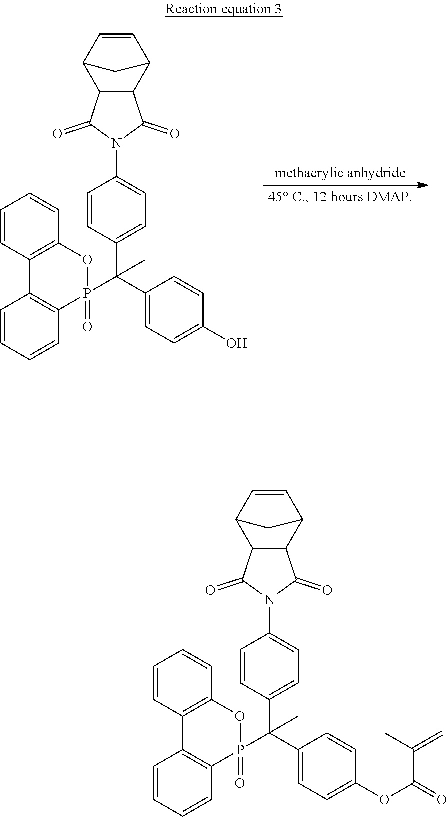 [SMILES: CC(c1ccc(O)cc1)(c1ccc(N2C(=O)C3C4C=CC(C4)C3C2=O)cc1)P1(=O)Oc2ccccc2-c2ccccc21 ; C=C(C)C(=O)Oc1ccc(C(C)(c2ccc(N3C(=O)C4C5C=CC(C5)C4C3=O)cc2)P2(=O)Oc3ccccc3-c3ccccc32)cc1]

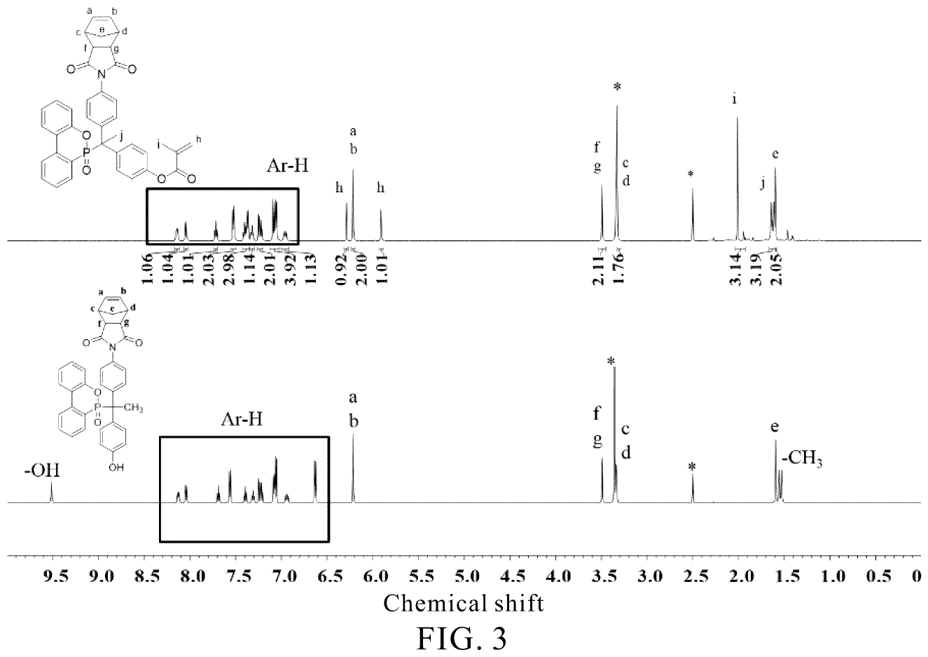

As shown in Reaction equation 3, 2.00 g (0.0035 mol) of phosphorus-based monomer (2), 0.7 g (0.0035*1.3 mmol) of methacrylic anhydride, 0.02 g (1 wt % of NOR-DOPO) of 4-dimethylaminopyridine (DMAP), 10 mL of N,N-dimethylacetamide (DMAc) are stirred in a 100 mL three-neck reactor, nitrogen is introduced, and the temperature is raised to 45° C. After reacting for 12 hours, the product is dropped into pure water to be precipitated, a filter cake is taken by filtration and washed repeatedly with pure water, and dried to obtain a white powder, and whose 1H-NMR spectrum is shown in FIG. 3.

### Synthesis Embodiment 2-2: Synthesis of Functionalized Phosphorus-Based Monomer (2)

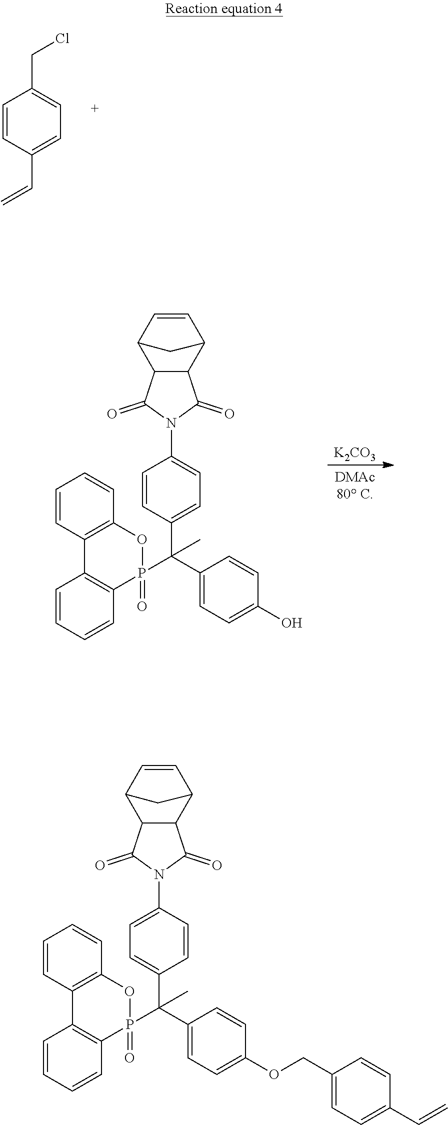

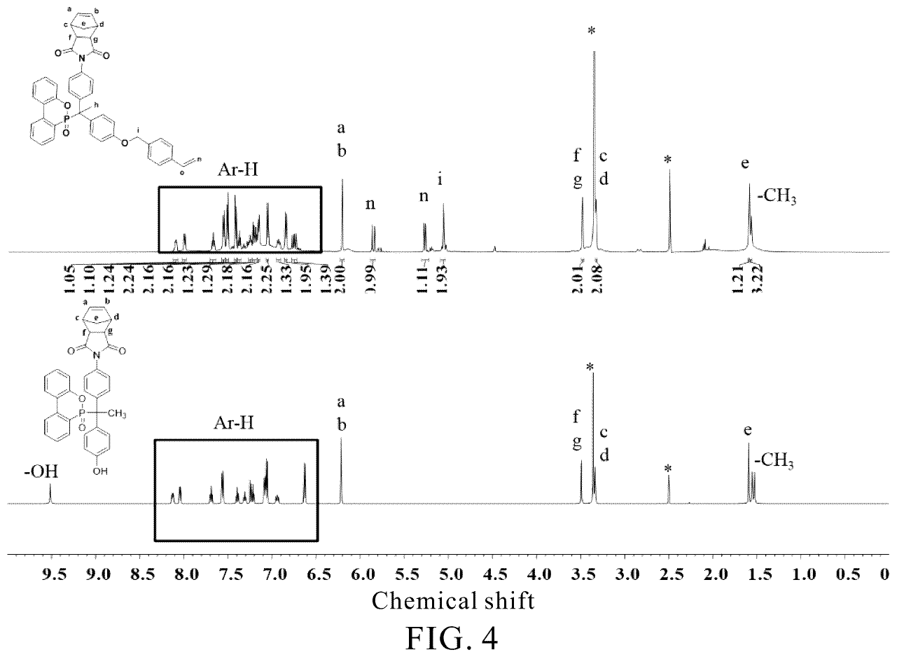

As shown in Reaction equation 4, 2.00 g (0.0035 mol) of phosphorus-based monomer (2), 0.69 g (0.0035*1.3 mmol) of 4-vinylbenzyl chloride, 0.63 g of potassium carbonate (K₂CO₃), 30 mL of N,N-dimethylacetamide (DMAc) are stirred in a 100 mL three-neck reactor, nitrogen is introduced, and the temperature is raised to 80° C. After reacting for 12 hours, the product is dropped into pure water to be precipitated, a filter cake is taken after suction filtration, and rinsed repeatedly with pure water, and dried to obtain a white powder, and whose 1H-NMR spectrum is shown in FIG. 4.

### Synthesis Embodiment 3

### Synthesis Embodiment 3-1: Cyclic Olefin Copolymer (1)

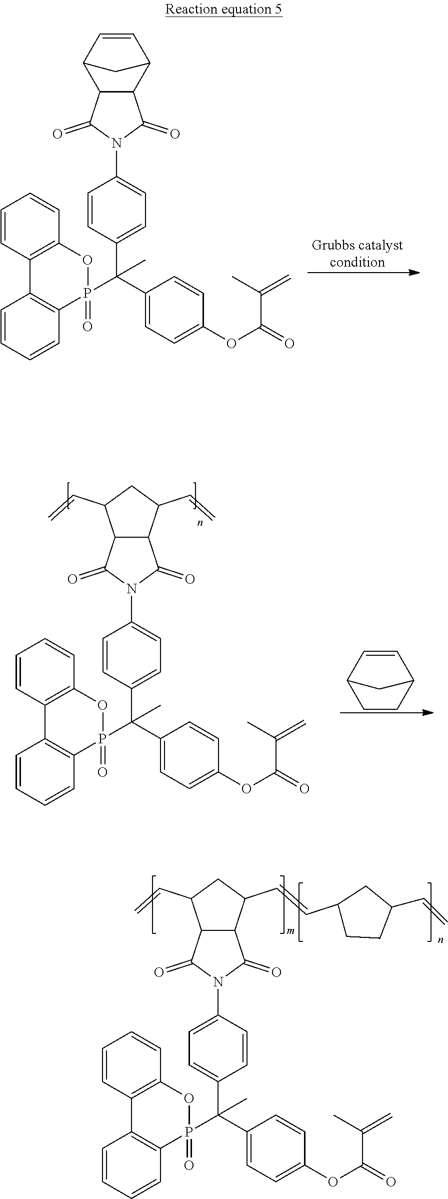

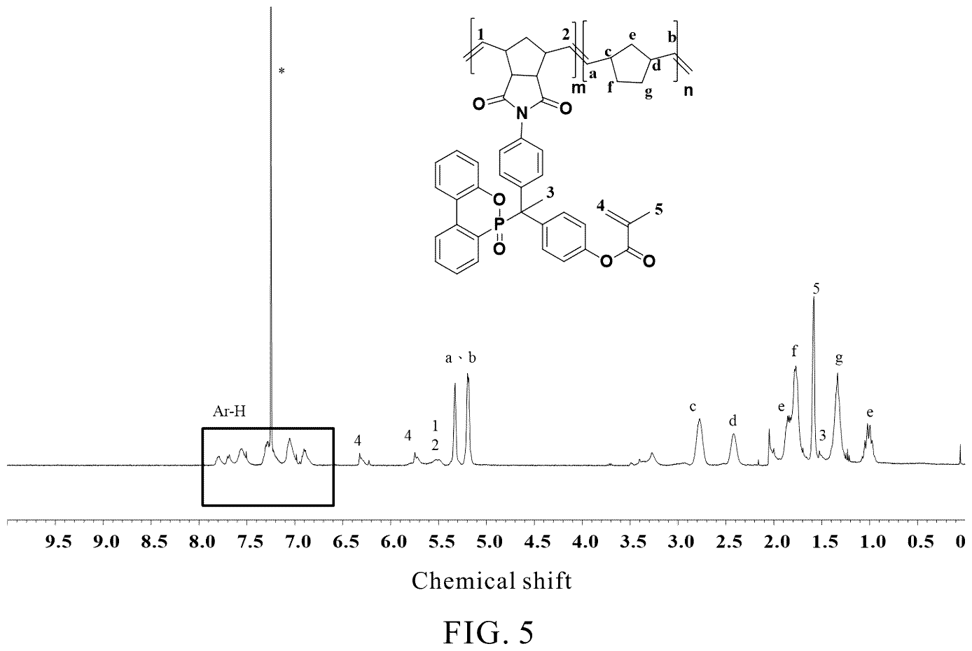

As shown in Reaction equation 5, 1.06 g (0.0053*0.3 mol) of functionalized phosphorus-based monomer (1) and 5 mL of DMAc are prepared into a solution, 0.02 g (0.5% mol) of Grubbs catalyst 2ND Generation and 2 mL of N,N-dimethylacetamide (DMAc) are prepared into a solution and then placed in a reactor and stirred, nitrogen is introduced to carry out the reaction at room temperature. After reacting for 1 hour, 0.5 g (0.0053 mol) of norbornene and 5 mL of DMAc are added to the reactor to continue the reaction for 1 hour, 3 mL of ethyl vinyl ether (EVE) is dropped, 2 hours later, it is precipitated and rinsed several times with methanol (MeOH), after suction filtration, it is dried at room temperature to obtain a white solid, and whose 1H-NMR spectrum is shown in FIG. 5.

### Synthesis Embodiment 3-2: Cyclic Olefin Copolymer (2)

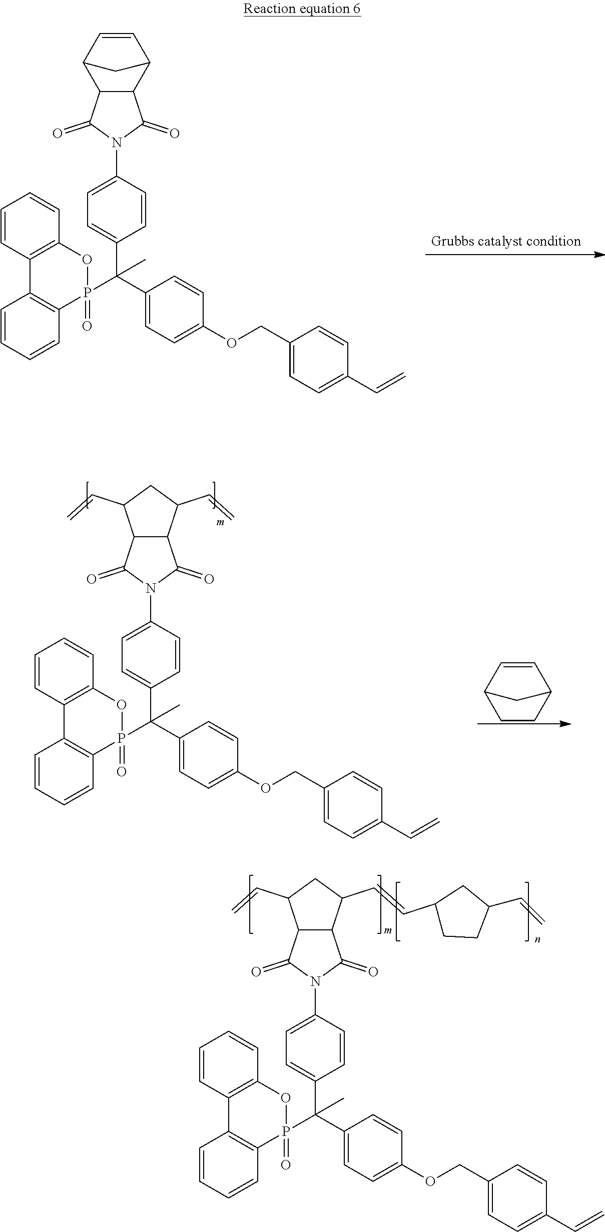

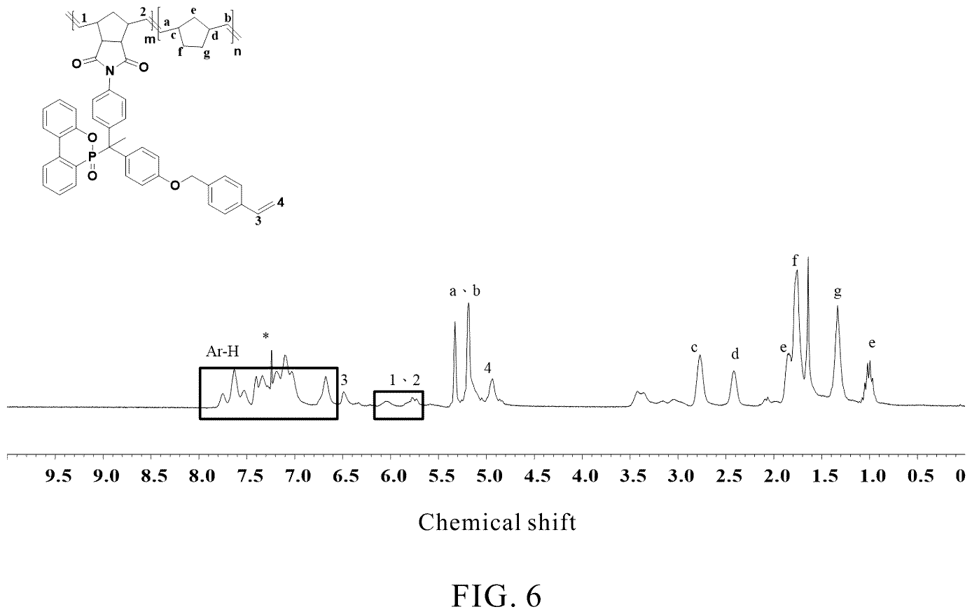

As shown in Reaction equation 6, 1.09 g (0.0053*0.3 mol) of functionalized phosphorus-based monomer (2) and 5 mL of N,N-dimethylacetamide (DMAc) are prepared into a solution, 0.02 g (0.5% mol) of Grubbs catalyst 2ND Generation and 2 mL of DMAc are prepared into a solution, and the above two solutions are placed in a reactor and stirred, nitrogen is introduced to carry out the reaction at room temperature. After reacting for 1 hour, 0.5 g (0.0053 mol) of norbornene and 5 mL of DMAc are prepared into a solution and added to the reactor to continue the reaction for 1 hour, 3 mL of ethyl vinyl ether (EVE) is dropped, 2 hours later, it is precipitated and rinsed several times with methanol (MeOH), after suction filtration, it is dried at room temperature to obtain a white solid, and whose 1H-NMR spectrum is shown in FIG. 6.

### Synthesis Embodiment 4

### Synthesis Embodiment 4-1: Cyclic Olefin Copolymer (3)

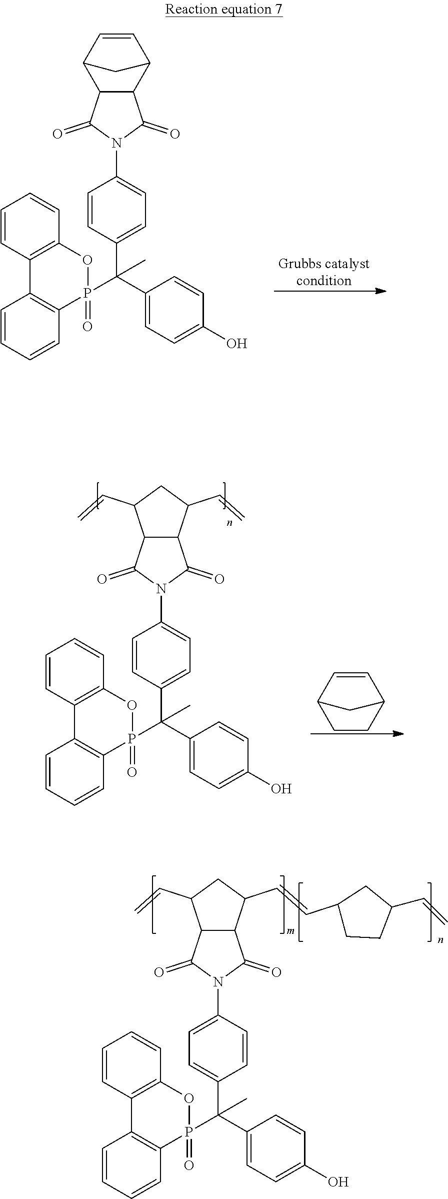

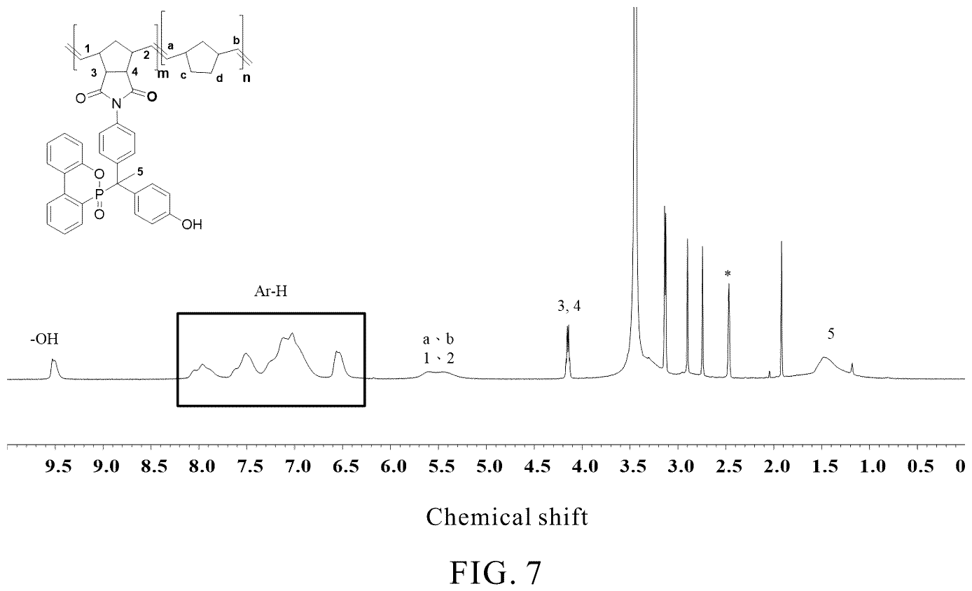

As shown in reaction equation 7, 0.9 g (0.0053*0.3 mol) of phosphorus-based monomer (2) and 5 mL of N,N-dimethylacetamide (DMAc) are prepared into a solution, 0.02 g (0.5% mol) of Grubbs catalyst 2ND Generation and 2 mL of DMAc are prepared into a solution, and the above two solutions are placed in a reactor and stirred, nitrogen is introduced to carry out the reaction at room temperature. After reacting for 1 hour, 0.5 g (0.0053 mol) of norbornene and 5 mL of DMAc are prepared into a solution and added to the reactor to continue the reaction for 1 hour, 3 mL of ethyl vinyl ether (EVE) is dropped, 2 hours later, it is precipitated and rinsed several times with methanol (MeOH), after suction filtration, it is dried at room temperature to obtain a white solid, and whose 1H-NMR spectrum is shown in FIG. 7.

### Synthesis Embodiment 4-2: Saturated Cyclic Olefin Copolymer (3)

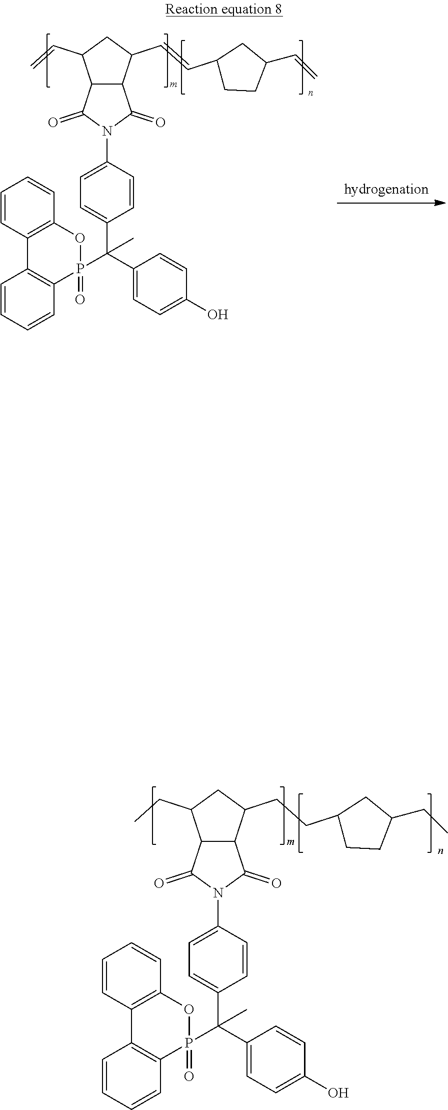

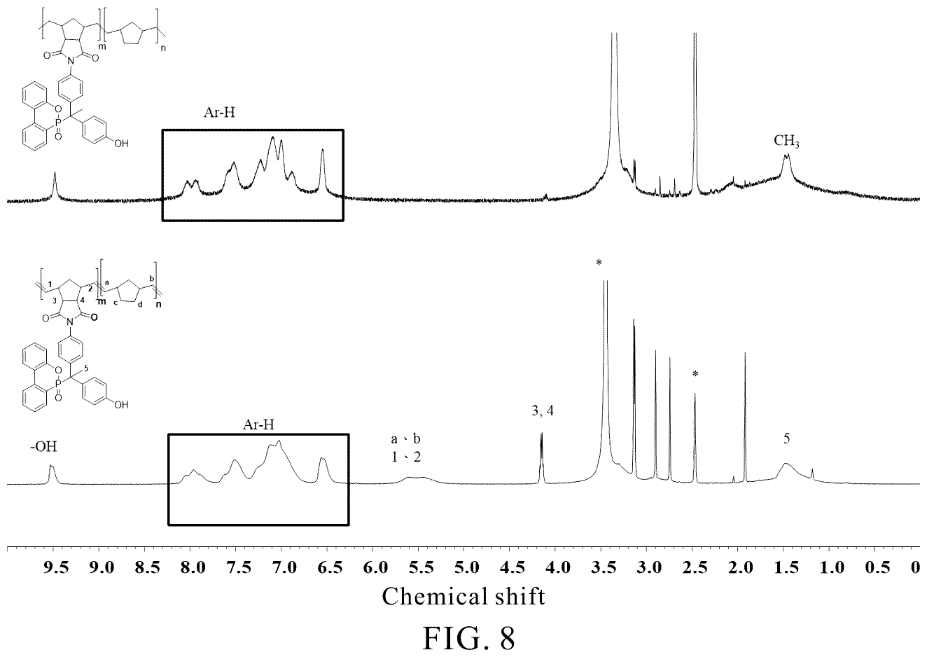

As shown in reaction equation 7, 2 g of cyclic olefin copolymer (3) and 30 mL of dimethylformamide (DMF) are prepared into a solution, the above solution and 8 g of p-toluenesulfonyl hydrazide are placed and stirred in a 100 mL reactor, and reacted at 130° C. After reacting 5 hours, it is precipitated and rinsed several times with methanol (MeOH), after suction filtration, it is dried at room temperature to obtain a yellow powder, and whose 1H-NMR spectrum is shown in FIG. 8.

### Synthesis Embodiment 4-3: Functionalized Saturated Cyclic Olefin Copolymer (1)

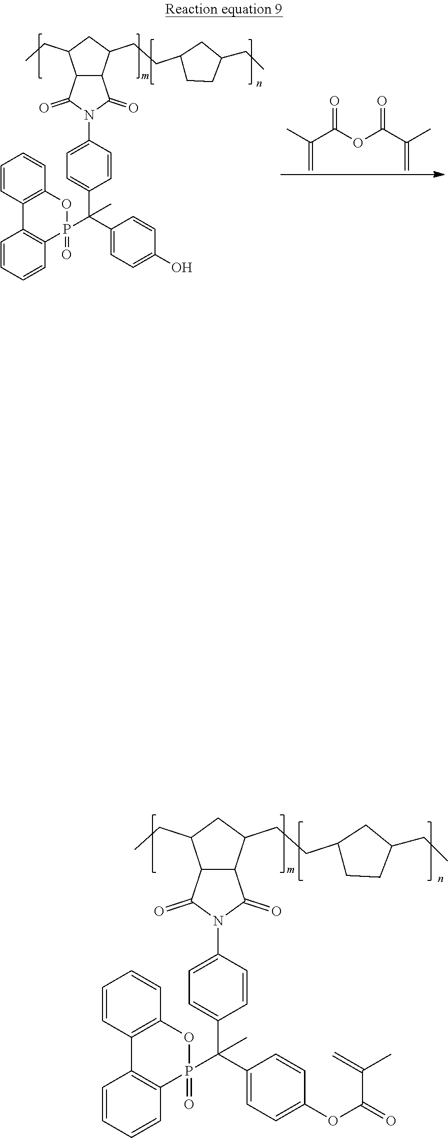

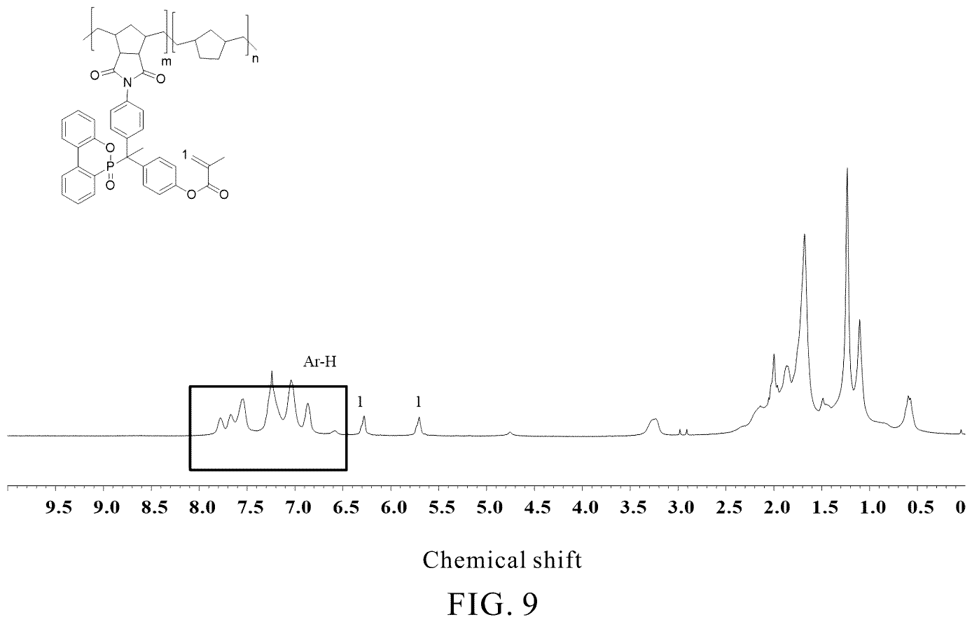

As shown in reaction equation 9, 2.00 g (0.0028 mol) of saturated cyclic olefin copolymer (3), 0.4 g (0.0028*0.3*1.3 mmol) of methacrylic anhydride, 0.02 g (2 wt % of NB-DOPO) of 4-dimethylaminopyridine (DMAP), 10 mL of N,N-dimethylacetamide (DMAc) are placed and stirred in a 100 mL three-neck reactor, nitrogen is introduced, and the temperature is raised to 80° C. After reacting for 12 hours, the product is dropped into methanol/water to be precipitated, a filter cake is taken after filtration, and rinsed repeatedly with methanol/water to obtain a white powder, and whose 1H-NMR spectrum is shown in FIG. 9.

### Synthesis Embodiment 5

### Synthesis Embodiment 5-1: Functionalized Saturated Cyclic Olefin Copolymer (2)

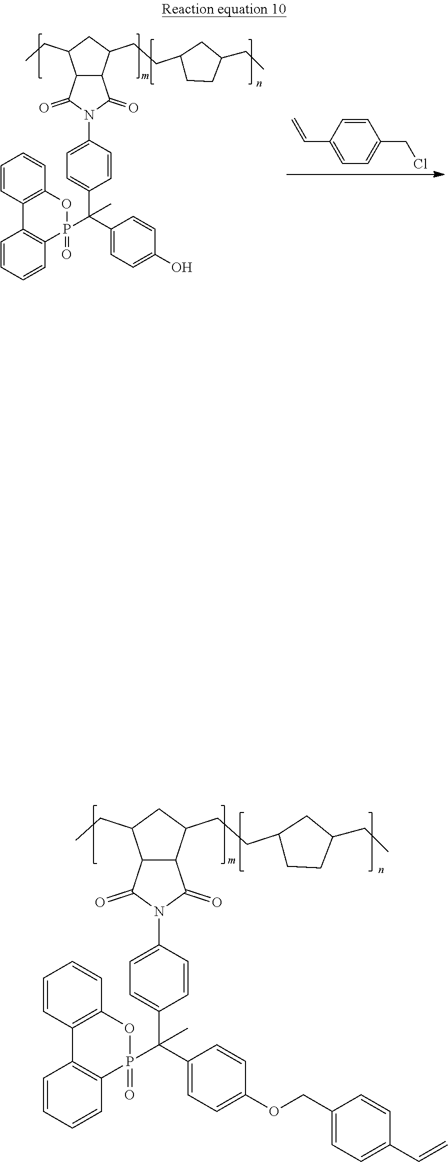

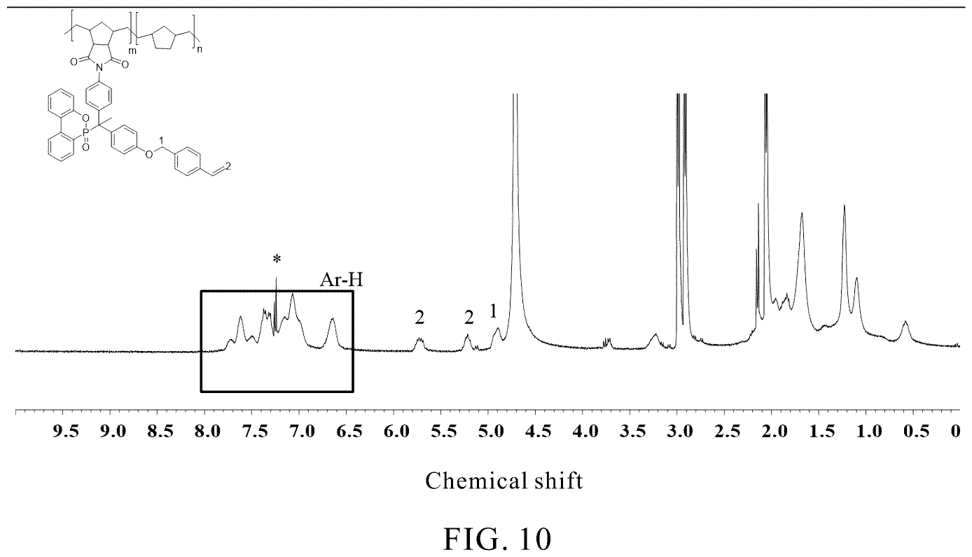

As shown in reaction equation 10, 2.00 g (0.0028 mol) of the saturated cyclic olefin copolymer (3) prepared in synthesis embodiment 4-2, 0.4 g (0.0028*0.3*1.3 mmol) of 4-vinylbenzyl chloride, 0.075 g of potassium carbonate (K₂CO₃), 30 mL of N,N-dimethylacetamide (DMAc) are placed and stirred in a 100 mL three-neck flask, nitrogen is introduced, and the temperature is raised to 80° C. After reacting for 12 hours, the product is dropped into methanol/water to be precipitated, a filter cake is taken after suction filtration, and rinsed repeatedly with methanol/water to obtain a white powder, and whose 1H-NMR spectrum is shown in FIG. 10.

### Test Example 1: Solubility Test of Copolymer

5 mg of the cyclic olefin copolymer (1), cyclic olefin copolymer (2), cyclic olefin copolymer (3), saturated cyclic olefin copolymer (3), functionalized saturated cyclic olefin copolymer (1) and functionalized saturated cyclic olefin copolymer (2) synthesized in the above synthesis embodiments 3 to 5 are respectively added in different solvents, in order to test the solubility of cyclic olefin copolymer (1), cyclic olefin copolymer (2), cyclic olefin copolymer (3), saturated cyclic olefin copolymer (3), functionalized saturated cyclic olefin copolymer (1) and functionalized saturated cyclic olefin copolymer (2) in different solvents.

The results are shown in Table 1 below. Cyclic olefin copolymer (1), cyclic olefin copolymer (2), functionalized saturated cyclic olefin copolymer (1), functionalized saturated cyclic olefin copolymer (2) are soluble in most common solvents, that is, functionalized saturated cyclic olefin copolymer (1) and functionalized saturated cyclic olefin copolymer (2) have high solvent properties. The high solvent properties of functionalized saturated cyclic olefin copolymer (1) and functionalized saturated cyclic olefin copolymer (2) are helpful for the application of copper foil substrate manufacturing processes.

TABLE 1

| | N,N- | | N- | | |
|---|---|---|---|---|---|
| | dimethyl- | | methylpyr- | Tetrahy- | |
| | acetamide | | rolidone | drofuran | |
| | (DMAc) | Toluene | (NMP) | (THF) | Xylene |
| Cyclic olefin | − | + | − | + | + |
| copolymer (1) | | | | | |
| Cyclic olefin | − | + | − | + | + |
| copolymer (2) | | | | | |
| Cyclic olefin | + | − | + | + | − |
| copolymer (3) | | | | | |
| saturated cyclic | +h | − | +h | +h | − |
| olefin | | | | | |
| copolymer (3) | | | | | |
| functionalized | +h | +h | +h | +h | +h |
| saturated cyclic | | | | | |
| olefin | | | | | |
| copolymer (1) | | | | | |
| functionalized | +h | +h | +h | +h | +h |
| saturated cyclic | | | | | |
| olefin | | | | | |
| copolymer (2) | | | | | |

+: soluble at room temperature;
+h: soluble after heating

### Preparation of Cyclic Olefin Copolymer Cured Product

For example, cured products formed by the cyclic olefin copolymer of the present disclosure can be prepared by the following preparation examples 1-4:

### Preparation Example 1: Preparation of Cyclic Olefin Copolymer Cured Product 1

First, the cyclic olefin copolymer (1) synthesized in synthesis embodiment 3-1 is dissolved in a solvent of toluene, and tert-butyl cumyl peroxide (TBCP) is added at 10 wt % of the cyclic olefin copolymer to obtain a copolymer composition 1 with a solid content of 10 wt %.

The above-mentioned copolymer composition 1 is placed on an aluminum pan, and then the aluminum pan containing the copolymer composition 1 is placed in a circulation oven, and dried at 80° C. for 8 hours to remove most of the solvent, and then sequentially raised to 120° C., 180° C., 200° C., 220° C. (two hours each) in a phased heating mode for curing. Next, the aluminum pan is demolded in an etching solution to obtain a cyclic olefin copolymer cured product 1.

### Preparation Example 2: Preparation of Cyclic Olefin Copolymer Cured Product 2

The cyclic olefin copolymer cured product 2 is prepared in a method similar to that of the preparation example 1, and the difference is only that the cyclic olefin copolymer (2) synthesized by the synthesis embodiment 3-2 is used instead of the cyclic olefin copolymer (1) of the synthesis embodiment 3-1.

### Preparation Example 3: Preparation of Saturated Cyclic Olefin Copolymer Cured Product 1

The saturated cyclic olefin copolymer cured product 1 is prepared in a method similar to that of the preparation example 1, and the difference is only that the functionalized saturated cyclic olefin copolymer (1) synthesized by the synthesis embodiment 4-3 is used instead of the cyclic olefin copolymer (1) of the synthesis embodiment 3-1.

### Preparation Example 4: Preparation of Saturated Cyclic Olefin Copolymer Cured Product 2

The saturated cyclic olefin copolymer cured product 2 is prepared in a method similar to that of the preparation example 1, and the difference is only that the functionalized saturated cyclic olefin copolymer (2) synthesized by the synthesis embodiment 5-1 is used instead of the cyclic olefin copolymer (1) of the synthesis embodiment 3-1.

### Comparative Preparation Example 1: Preparation of Comparative Cured Product 1

The comparative cured product 1 is prepared in a method similar to preparation example 1. The difference is only that a commercially available SA9000 merchandise is used instead of the cyclic olefin copolymer (1) synthesized in the synthesis embodiment 3-1.

### Comparative Preparation Example 2: Preparation of Comparative Cured Product 2

The comparative cured product 2 is prepared in a method similar to preparation example 1. The difference is only that a commercially available OPE-2ST merchandise is used instead of the cyclic olefin copolymer (1) synthesized in the synthesis embodiment 3-1.

### Test Example 2: Evaluation of Thermal Properties, Dielectric Ability and Flame Retardancy of the Cyclic Olefin Copolymer Cured Product

The thermal properties and dielectric ability of the cyclic olefin copolymer cured product 1, cyclic olefin copolymer cured product 2, saturated cyclic olefin copolymer cured product 1, saturated cyclic olefin copolymer cured product 2 prepared in the preparation examples 1~4 and the comparative cured product 1 and comparative cured product 2 prepared in the comparative examples 1-2 are evaluated by the following method. The results are listed in Table 2.

### (1) Glass Transition Temperature (Tg):

Thermo-mechanical analysis (TMA) is used to measure the glass transition temperature. The conditions for thermo-mechanical analysis are to use a dynamic mechanical analyzer (DMA) (model: Perkin-Elmer Pyris Diamond) to measure the glass transition temperature of the sample at a heating rate of 5° C./min.

Dynamic mechanical analysis (DMA) diagrams of cyclic olefin copolymer cured product 1, cyclic olefin copolymer cured product 2, saturated cyclic olefin copolymer cured product 1, and saturated cyclic olefin copolymer cured product 2 are obtained, the data of which are organized in Table 2.

### (2) 5% Thermogravimetric Loss Temperature (Td5%) and Char Yield:

Thermogravimetric analysis (TGA) is used to measure the 5% thermogravimetric loss temperature and the char yield at 800° C. of the sample. The conditions for thermogravimetric analysis are to use a thermogravimetric analyzer (model: Thermo Cahn VersaTherm) to measure the weight change of the sample under a nitrogen atmosphere at a heating rate of 20° C./min. The 5% thermogravimetric loss temperature refers to the temperature at which the weight loss of the sample reaches 5%, wherein the higher the 5% thermogravimetric loss temperature, the better the thermal stability of the sample. The char yield at 800° C. refers to the residual weight ratio of the sample when the heating temperature reaches 800° C., wherein the higher the residual weight ratio at 800° C., the better the thermal stability of the sample.

### (3) Dielectric Constant (Dk) and Loss Tangent (Df):

The dielectric constant (Dk) and loss tangent (Df) of the sample are measured at 25° C. and 10 GHz using Rohde Schwarz/Steel/ZNB20 from Taiwan.

TABLE 2

| | coefficient of | | | | | |
|---|---|---|---|---|---|---|
| | thermal expansion | Tg (° C.) | | Char yield | | |
| | (CTE) (ppm/° C.) | (DMA) | Td5% (° C.) | (%) | Dk | Df |
| Cyclic olefin | 89 | 149/288 | 432 | 3.4 | 2.42 | 0.0093 |
| copolymer | | | | | | |
| cured product | | | | | | |
| 1 | | | | | | |
| Cyclic olefin | 85 | 341 | 423 | 14.3 | 2.55 | 0.0078 |
| copolymer | | | | | | |
| cured product | | | | | | |
| 2 | | | | | | |
| Saturated | 88 | 284 | 400 | 5.5 | 2.25 | 0.0038 |
| cyclic olefin | | | | | | |
| copolymer | | | | | | |
| cured product | | | | | | |
| 1 | | | | | | |
| Saturated | 65 | 288 | 445 | 9.8 | 2.52 | 0.0039 |
| cyclic olefin | | | | | | |
| copolymer | | | | | | |
| cured product | | | | | | |
| 2 | | | | | | |
| Comparative | 63 | 235 | 457 | 20 | 2.70 | 0.0030 |
| cured product | | | | | | |
| 1 | | | | | | |
| Comparative | 76 | 229 | 394 | 27 | 2.75 | 0.0060 |
| cured product | | | | | | |
| 2 | | | | | | |

### (4) Flame Retardancy Test

The experiment complies with the UL-94 test standard, it is conducted on a 5 inch×0.5 inch film, the film is placed vertically, and the fire source burns the sample from bottom to top for 10 seconds. After the fire source is removed, the continuous burning time is observed, and whether there are any droplets dripping into the absorbent cotton below. The test results of the experiment are shown in Table 3 below.

TABLE 3

| | First | Second | | |
|---|---|---|---|---|
| | continuous | continuous | | flame |
| | burning | burning | | retardancy |
| | time (sec) | time (sec) | droplets | rating (VTM) |
| Cyclic olefin | >10 | * | occurrence | V-2 |
| copolymer | | | | |
| cured product | | | | |
| 1 | | | | |
| Cyclic olefin | 1.2 | 0.3 | none | V-0 |
| copolymer | | | | |
| cured product | | | | |
| 2 | | | | |
| Saturated | 1.8 | 0.2 | none | V-0 |
| cyclic olefin | | | | |
| copolymer | | | | |
| cured product | | | | |
| 1 | | | | |
| Saturated | 2.3 | 0.3 | [symbol] | V-0 |
| cyclic olefin | | | | |
| copolymer | | | | |
| cured product | | | | |
| 2 | | | | |
| Comparative | 1.38 | 1.98 | [symbol] | V-0 |
| cured product | | | | |
| 1 | | | | |
| Comparative | X | X | occurrence | VTM-2 |
| cured product | | | | |
| 2 | | | | |

Referring to Table 2, in the test of thermo-gravimetric analysis (TGA), the 5% thermogravimetric loss temperatures of cyclic olefin copolymer cured product 1, cyclic olefin copolymer cured product 2, saturated cyclic olefin copolymer cured product 1 and saturated cyclic olefin copolymer cured product 2 prepared by the cyclic olefin copolymer of the present disclosure are respectively 432° C., 423° C., 400° C. and 445° C. In addition, the char yields of cyclic olefin copolymer cured product 1, cyclic olefin copolymer cured product 2, saturated cyclic olefin copolymer cured product 1 and saturated cyclic olefin copolymer cured product 2 are respectively 3.4%, 14.3%, 5.5%, and 9.8%, showing that the cured product prepared by the cyclic olefin copolymer of the present disclosure has good thermal stability (i.e., heat resistance).

In addition, in the evaluation of the dielectric ability of the cyclic olefin cured product, the dielectric constants of the cyclic olefin copolymer cured product 1, the cyclic olefin copolymer cured product 2, the saturated cyclic olefin copolymer cured product 1, and the saturated cyclic olefin copolymer cured product 2 prepared by the cyclic olefin copolymer of the present disclosure are between 2.2 and 2.6, and the loss tangents are between 0.003 and 0.01, and the loss tangent is no less than that of the traditional PPE resin cured product.

In addition, in the flame retardancy test, it can be seen from Table 3 that the cyclic olefin copolymer cured product 1, the cyclic olefin copolymer cured product 2, the saturated cyclic olefin copolymer cured product 1, and the saturated cyclic olefin copolymer cured product 2 prepared by the cyclic olefin copolymer of the present disclosure are significantly better than the commercially available OPE-2ST products in flame retardant effect. It shows that the cured products prepared by the cyclic olefin copolymer of the present disclosure have good flame retardancy.

In summary, the cyclic olefin copolymer of the present disclosure has a linear phosphorus-containing aliphatic structure, and the copolymer is cross-linked with the polyphenylene ether (PPE) resin, and the heat resistance and flame resistance of the cured product of the PPE resin are improved without affecting the dielectric constant and loss tangent of the cured product. In addition, the cyclic olefin copolymer cured product prepared by the cyclic olefin copolymer composition of the above embodiment has high processability, high heat resistance, good dielectric ability, high toughness and flame retardancy.

While the present invention has been disclosed as above by embodiments, it is not used to limit the present invention, and any person having ordinary knowledge in the art to which it belongs may make some changes and embellishments without departing from the spirit and scope of the invention, so the scope of protection of the present invention shall be defined by the claims attached hereafter.

What is claimed is:

1. A cyclic olefin copolymer, having a structure as shown in Formula (I-1) or 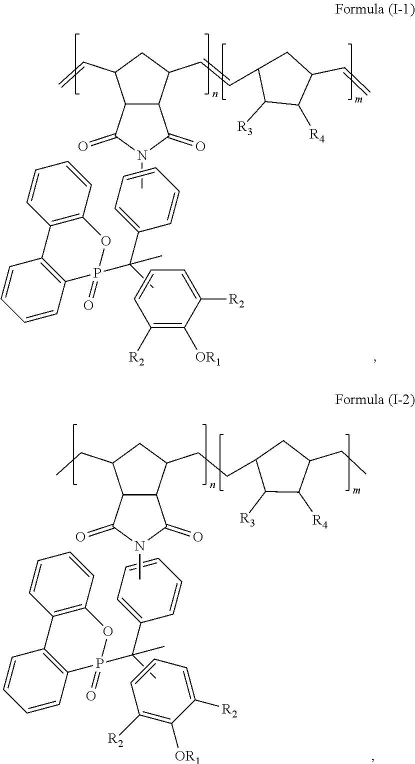
wherein R₁ is 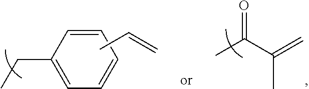
R₂ is hydrogen, halogen or C₁-C₆ alkyl, R₃ and R₄ are independently selected from the groups consisting of hydrogen, C₁-C₆ alkyl, phenyl group and CF₃ group, n is a positive integer from 5 to 200, m is a positive integer from 5 to 200.

2. The cyclic olefin copolymer according to claim 1, having a structure as shown in Formula (II):

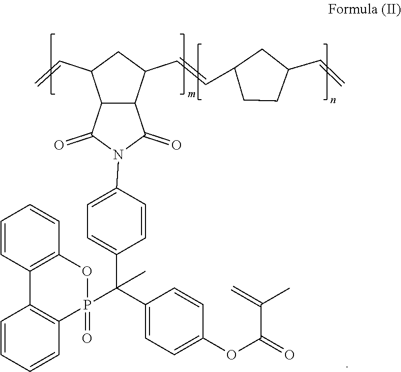

3. The cyclic olefin copolymer according to claim 1, having a structure as shown in Formula (III):

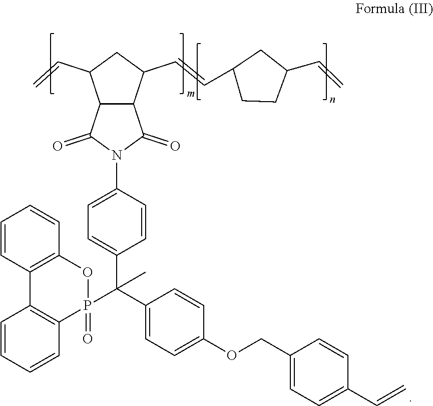

4. The cyclic olefin copolymer according to claim 1, having a structure as shown in Formula (IV):

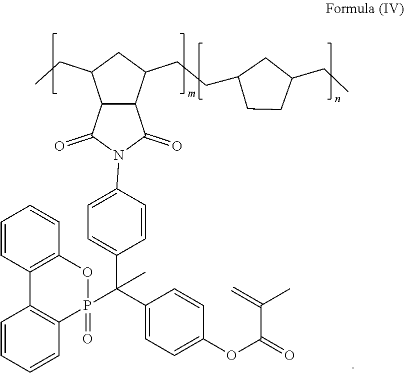

5. The cyclic olefin copolymer according to claim 1, having a structure as shown in Formula (V):

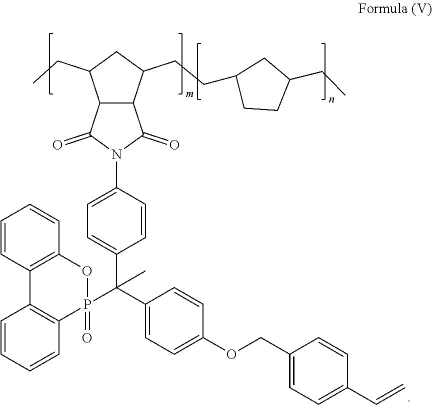

6. A curable composition, comprising:
the cyclic olefin copolymer according to claim 1; and
a curing accelerator.

7. The curable composition according to claim 6, wherein the curing accelerator is selected from the groups consisting of an imidazole-based curing accelerator, an amine-based curing accelerator and an organophosphorus-based curing accelerator.

8. The curable composition according to claim 7, wherein the imidazole-based curing accelerator is selected from the groups consisting of imidazole, 2-methylimidazole and 2-methyl-4-ethylimidazole.

9. The curable composition according to claim 7, wherein the amine-based curing accelerator is 4-dimethylaminopyridine (DMAP).

10. The curable composition according to claim 7, wherein the organophosphorus-based curing accelerator is triphenylphosphine.
